(19) United States
(12) Patent Application Publication
(10) Pub. No.: US 2024/0403273 A1
(43) Pub. Date: Dec. 5, 2024

(54) SYSTEMS AND METHODS FOR DYNAMIC GEOTEMPORAL DATA SCHEMAS

(71) Applicant: Palantir Technologies Inc., Denver, CO (US)

(72) Inventors: Daniel Zangri, Austin, TX (US); Nicholas Morgan, Salt Lake City, UT (US); Hunter Herman, Palo Alto, CA (US)

(21) Appl. No.: 18/678,300

(22) Filed: May 30, 2024

Related U.S. Application Data
(60) Provisional application No. 63/554,502, filed on Feb. 16, 2024.
(60) Provisional application No. 63/469,932, filed on May 31, 2023.

(51) Int. Cl. G06F 16/21

(52) U.S. Cl. CPC G06F 16/212

(57) ABSTRACT

Systems and methods for managing and/or using observation schemas are provided. In some embodiments, a method includes receiving a data stream from one or more data sources; accessing a first observation schema including one or more built-in fields and one or more custom fields associated with the received data stream; receiving a configuration associated with at least one of the one or more custom fields; and generating a second observation schema based on the configuration and the first observation schema.

### CROSS REFERENCE TO RELATED APPLICATIONS

This application claims priority to U.S. Provisional Application No. 63/554,502, filed Feb. 16, 2024, and U.S. Provisional Application No. 63/469,932, filed May 31, 2023, each of which is incorporated by reference herein for all purposes.

### TECHNICAL FIELD

Certain embodiments of the present disclosure are directed to data schemas. More particularly, some embodiments of the present disclosure provide systems and methods for generating, updating, and/or managing observation schemas (e.g., geotemporal data schemas).

### BACKGROUND

Large data streams are often captured and used. For example, sensor data and/or geotemporal data may be collected for entities. In some cases, sensor data and/or geotemporal data may be collected for entities from multiple data sources (e.g., multiple sensors), such that it becomes complicated to ingest such data. Hence it is highly desirable to improve the techniques for data ingestion.

### SUMMARY

Certain embodiments of the present disclosure are directed to data schemas. More particularly, some embodiments of the present disclosure provide systems and methods for generating, updating, and/or managing observation schemas (e.g., geotemporal data schemas).

According to some embodiments, a method for managing one or more observation schemas, the method comprising: receiving a data stream from one or more data sources; accessing a first observation schema including one or more built-in fields and one or more custom fields associated with the received data stream; receiving a configuration associated with at least one of the one or more custom fields; and generating a second observation schema based on the configuration and the first observation schema; wherein at least a part of the method is performed using one or more processors.

According to certain embodiments, a method for using one or more observation schemas, the method comprising: receiving a data stream from one or more data sources; searching within the one or more observation schemas in a data repository based on at least one data characteristic in the data stream; identifying an observation schema from the one or more observation schemas based on the search; and processing the data stream using the identified observation schema to generate a plurality of observations; wherein at least a part of the method is performed using one or more processors.

According to some embodiments, a system for managing one or more observation schemas, the system comprising: one or more memories having instructions stored thereon; and one or more processors configured to execute the instructions and perform operations comprising: receiving a data stream from one or more data sources; accessing a first observation schema including one or more built-in fields and one or more custom fields associated with the received data stream; receiving a configuration associated with at least one of the one or more custom fields; and generating a second observation schema based on the configuration and the first observation schema.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a system for streaming, storing, and processing real-time data according to certain embodiments of the present disclosure.

FIG. 2 is a simplified diagram showing a computing system for implementing one or more components or all components of the system for streaming, storing, and processing real-time data in accordance with at least one example set forth in the disclosure.

FIG. 3 illustrates an example diagram for entities according to some embodiments of the present disclosure.

FIG. 4 is a simplified diagram showing a method for generating and/or managing observation schemas according to certain embodiments of the present disclosure.

FIG. 5 is a simplified diagram showing a method for managing and/or using observation schemas according to certain embodiments of the present disclosure.

FIG. 6 is an illustrative example of a software architecture and/or a software system for generating, using, and/or managing observation schemas, according to certain embodiments of the present disclosure.

FIG. 7 illustrates an example observation schema, including one or more built-in fields and one or more custom fields, according to certain embodiments of the present disclosure.

FIG. 8 illustrates an example user interface that allows a user to configure and/or select an observation schema, according to certain embodiments of the present disclosure.

### DETAILED DESCRIPTION

Certain embodiments of the present disclosure are directed to data schemas. More particularly, some embodiments of the present disclosure provide systems and methods for generating, updating, and/or managing observation schemas (e.g., geotemporal data schemas).

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods usually include fixed data schemas for data ingestion and using the ingested data. Conventional systems and methods cannot handle various data sources (e.g., geotemporal data, sensor data, etc.) without significant efforts to generate data schemas including various data formats to ingest data. Further, conventional systems and methods often store all data fields of data objects.

Various embodiments of the present disclosure can achieve benefits and/or improvements by a computing system, for example, using dynamic data schemas (e.g., observation schemas) that can be generated and/or updated in runtime. In certain embodiments, a data schema, also referred to as an observation schema, includes one or more data objects and/or one or more data fields. In some embodiments, a data object includes one or more data fields. In some embodiments, benefits include significant improvements to data quality when capturing observation data using the dynamic data schemas. In certain embodiments, benefits include reducing network consumptions and/or reducing storage space with dynamic data schemas including both live data fields and static data fields, where live data fields are updated (e.g., receiving and/or populating data in the data fields) at a data rate higher than the update of the static data fields. In some embodiments, benefits include reducing network consumptions and/or reducing storage space by a computing system updating some of the data fields (e.g., live fields) at a first data rate (e.g., 5 inputs per second) and some of the data fields (e.g., static fields) at a second data rate (e.g., one input per day), where the first data rate is higher than the second data rate.

In certain embodiments, benefits include improving computing efficiency and reducing the use of computing resources (e.g., processing time) in the data ingestion process by allowing configuring data fields in runtime. In some embodiments, benefits further include improving computing efficiency and/or improving data ingestion accuracy by generating dynamic data schemas automatically, for example, using a language model or other computing models.

According to certain embodiments, a language model (“LM”) may include an algorithm, rule, model, and/or other programmatic instructions that can predict the probability of a sequence of words. In some embodiments, a language model may, given a starting text string (e.g., one or more words), predict the next word in the sequence. In certain embodiments, a language model may calculate the probability of different word combinations based on the patterns learned during training (based on a set of text data from books, articles, websites, audio files, etc.). In some embodiments, a language model may generate many combinations of one or more next words (and/or sentences) that are coherent and contextually relevant. In certain embodiments, a language model can be an advanced artificial intelligence algorithm that has been trained to understand, generate, and manipulate language. In some embodiments, a language model can be useful for natural language processing, including receiving natural language prompts and providing natural language responses based on the text on which the model is trained. In certain embodiments, a language model may include an n-gram, exponential, positional, neural network, and/or other type of model.

According to some embodiments, a large language model (“LLM”) includes any type of language model that has been trained on a larger data set and has a larger number of training parameters compared to a regular language model. In certain embodiments, an LLM can understand more intricate patterns and generate text that is more coherent and contextually relevant due to its extensive training. In some embodiments, an LLM may perform well on a wide range of topics and tasks. In certain embodiments, an LLM may comprise an artificial neural network trained using self-supervised learning. In some examples, an LLM may include a question-answer (“QA”) LLM that may be optimized for generating answers from a context. In some embodiments, a language model may include an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like.

In certain embodiments, as high-scale, real-time data become increasingly common and vital to certain user workflows, analytical features that display and process that data have become important parts of users' tools. As an example, in operational use-cases, live location and signals data usually are the bread-and-butter of creating a trustworthy and seamless shared understanding of an area, which ultimately, for example, allows users to quickly and safely react to complex situations.

In some embodiments, a system (e.g., a backend system) for streaming, storing, and processing real-time data is provided. For example, the system (e.g., the backend system) for streaming, storing, and processing real-time data is built using one or more storage layers, one or more computation layers, and/or one or more query layers to serve as a fast and/or horizontally-scalable solution for different shapes and/or sizes of real-time data.

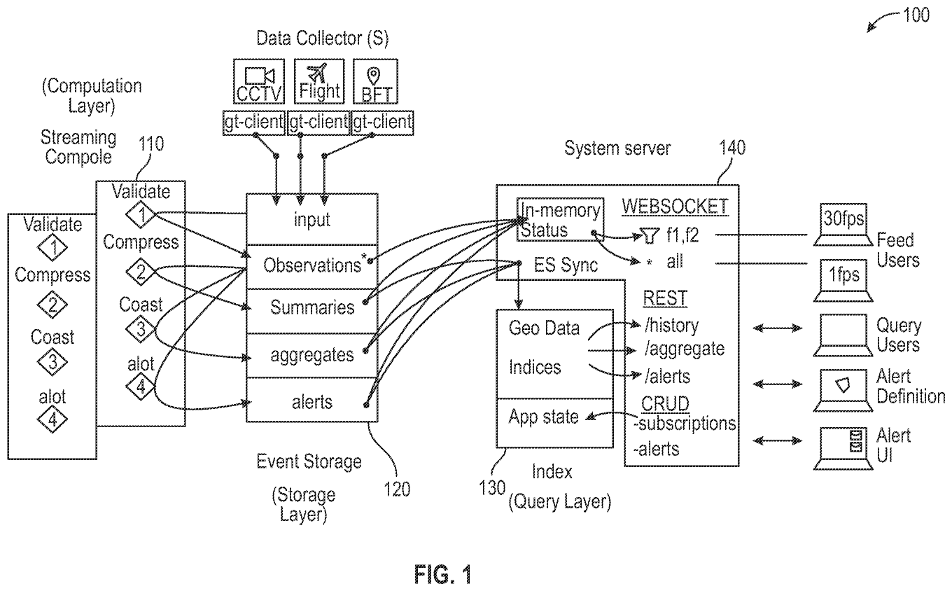

FIG. 1 is a simplified diagram showing a system for streaming, storing, and processing real-time data according to certain embodiments of the present disclosure. This diagram is merely an example. One of ordinary skill in the art would recognize many variations, alternatives, and modifications. For example, the system 100 for streaming, storing, and processing real-time data includes a computation layer 110, a storage layer 120, a query layer 130, and a system server 140. Although the above has been shown using a selected group of components for the system for streaming, storing, and processing real-time data, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present disclosure.

In some examples, the system 100 (e.g., a backend system) for streaming, storing, and processing real-time data is configured to perform one or more or all of the following tasks:
1. Provide a low-latency system for streaming real-time location data according to certain embodiments.
2. Provide a system for querying and/or aggregating historical location data collected for longer-term storage (e.g., with one or more retention controls) according to some embodiments.
3. Provide real-time geofence alerting for data entering the system that meet one more configurable queries according to certain embodiments.
4. Act as a source by which geotemporal series can be referenced from one or more certain objects according to some embodiments.
5. Provide one or more APIs for bulk uploading data to the system's history store according to certain embodiments.

In certain examples, the system 100 (e.g., a backend system) for streaming, storing, and processing real-time data provides two broad paths for data entering the system:
1. Fast path: data entering the system is written to the storage layer 120 according to some embodiments. For example, the computation layer 110 performs basic validation. As an example, the system server 140 sends the data out over any active, relevant data subscription
2. Slow path: after passing through the fast path, the computation layer 110 performs one or more processing jobs on the data for one or more or all of the following tasks according to certain embodiments:
   a) Data summarization: before the data is stored in the query layer 130 for querying, data is deduplicated by one or more configurable levels of time and distance (e.g., users of the system 100 can determine that for a data type, they wish to only save a single point for a time period of Y length if the entity has moved less than X meters) according to some embodiments.
   b) Alerts: perform real-time alerting, such as when an entity enters and/or exits a user-defined region, according to certain embodiments.
   c) Aggregations: bucketing data by one or more ire windows and/or filters to see one or more aggregate views (e.g., one or more histograms) of data flowing through the system 100 according to some embodiments.

In some examples, data entering the system 100 (e.g., a backend system) for streaming, storing, and processing real-time data includes the fields for series identification, entity identification, entity type, position, and timestamp (e.g., date and time). In certain embodiments, an entity refers to an object, a person, a moving object, a building, a static object, and/or the like. For example, one or more live data subscriptions, one or more history queries, and/or one or more alerts are represented as one or more queries over any of these fields. As an example, the data entering the system 100 (e.g., a backend system) contains one or more extra extension properties as additional metadata.

According to some embodiments, the system 100 (e.g., a backend system) for streaming, storing, and processing real-time data includes a separate integration service for basic real-time and/or bulk upload integrations. For example, the system 100 (e.g., a backend system) also provides a Java client for streaming data to the storage layer 120.

According to certain embodiments, the system 100 (e.g., a backend system) for streaming, storing, and processing real-time data provides a subscription API, a path history API, and an aggregation API. For example, the system 100 (e.g., a backend system) provides basic bulk upload functionality and/or real-time alerting.

According to some embodiments, data from the system 100 (e.g., a backend system) is viewed in one or more or all of the following ways:
a) Live layers
b) Track search
c) AI Aggregations
d) Real-time alerting
e) Track search
f) Track data linked to certain objects

Certain embodiments of the present disclosure include systems and methods for streaming geotemporal data. In some embodiments, stream processing is a fundamentally different paradigm from batch processes for two major reasons: 1) a stream of data can be arbitrarily large (e.g., for practical purposes, infinite); and 2) streams are often time-sensitive and made available to users in real-time. In some embodiments, time becomes a crucial aspect of streaming data. In certain embodiments, large amounts of data (e.g., infinite data) may not be practically stored. For example, a geotemporal data staging stack ingests greater than 40 GB of data every hour. In some examples, while data storage is cheap, at that rate, at most on-premises deployments, storage may be used up in days, if not hours.

In some embodiments, infinite data means the system processing the data cannot wait until all the data is available, then run a batch job. In certain embodiments, time sensitivity means the system can barely wait at all before processing data. For example, some systems demand sub-second (e.g., less than 1 second) latency. In certain embodiments, stream processing platforms have one or more of three parts: 1) an unbounded queue to accept writes from source systems; 2) a streaming data analysis framework that processes records from the queue; and 3) a traditional data store where analysis results get written.

According to certain embodiments, the system 100 includes features of tracking entities (e.g., objects, planes, ships, etc.) through time and space to support analytic workflows. For example, the analytic workflows include: showing where this ship has gone this year; and/or listing the planes that landed at this airport this month. In some embodiments, the system can receive streaming geotemporal data with sub-second latencies.

According to some embodiments, an observation refers to a location of an entity (e.g., an object) at a moment in time. In some embodiments, a track refers to a time series of observations. In certain embodiments, a lifecycle of an observation includes an input process, a validation process, and/or an analysis process. In some embodiments, the system includes one or more interactive parts for an observation. For example, the system includes an interface to allow receiving (e.g., writing) an observation (e.g., by a data source system), a communication channel (e.g., a websocket endpoint) that continually serves the latest observations, and/or a software interface (e.g., Conjure API) for building heatmaps, querying an entity's movements, and/or the like.

In some examples, a data structure for an observation includes a seriesType, seriesId and entityId. In certain examples, the seriesId is the unique identifier for the track that contains the observation (e.g., seriesId might be “A-airline997-november-8”). In some examples, the entityId is the unique identifier of an entity (e.g., “A-enterprise”) and the field can be used to query over the full set of tracks for the ones relevant to a specific entity. In certain examples, the seriesType corresponds to the data source, for example, a ship tracking service.

In certain embodiments, the observation's lifecycle begins with a push from a client source system. For example, a client system writes the observation to a proxy. As an example, the proxy forwards the observation to the tracking service. In some embodiments, the observation is serialized (e.g., Avro JSON). In certain embodiments, a validator job loads the observation, determines whether the observation is valid, and sends the observation (e.g., the serialized observation) to the tracking service based on whether the observation is valid or not. In some embodiments, if the observation is invalid, the observation is sent to a component for error inputs, for example, to determine why the observation is invalid. In certain embodiments, if the observation is valid, the observation is submitted for search indexing operations and/or for communication operations via communication channels (e.g., websockets, websocket APIs (application programming interface), duplex communication channels). In some embodiments, both search indexing and communication operations should be low-latency. In some embodiments, the communication operations have sub-second latencies, whereas search indexing operations can be an order of magnitude slower.

According to some embodiments, the search indexing operations include, for example, reading the valid observation, writing the newest observation for the entity to a search engine periodically (e.g., downsampling, less frequent than the frequency of receiving the observations), serving the observation's track and individual points to search clients by the search engine, and/or the like. In certain embodiments, the system loads the valid observation and checks if any clients have subscribed to updates about the observation (e.g., 22nd fleet). In some embodiments, for each client interested in the observation, the system 100 enqueues the observation. In certain embodiments, after applying some checks and/or analysis (e.g., Is bandwidth available? Does the client already have newer data?), the observation is sent to a client.

According to certain embodiments, the system 100 can be deployed in one or more remote environments (e.g., cloud environments) and/or one or more on-premises environments. In some embodiments, the system 100 can be deployed with single nodes for small form factor on-premises stacks.

According to some embodiments, an observation refers to an event at a time and/or geospatial location (e.g., place). In certain embodiments, an observation refers to an event at a time and geospatial location (e.g., a place, a GPS (global position system) ping). In certain embodiments, a track refers to a time series of observations from the same source (e.g., the history of places that a shark wearing a GPS tag has been). In certain embodiments, a track refers to a time series of observations from the same source (e.g., the history of places that a shark wearing a GPS tag has been). In some examples, observations are schematized according to observation specifications, also referred to as observation schemas or data schemas.

In some embodiments, observations are captured as data objects using the observation schemas, where a plurality of first observations including a first set of data fields update at first data rate (e.g., every one second) and a plurality of second observations including a second set of data fields at a second data rate (e.g., every one hour), where the first data rate is different from the second date rate. In certain embodiments, observations are captured as data objects using the observation schemas, where a plurality of first observations including a first set of data fields update at first data rate (e.g., every one second) and a plurality of second observations including a second set of data fields at a second data rate (e.g., every one hour), where the first data rate is higher than the second data rate. In certain embodiments, the first set of data fields is a subset of the second set of data fields. In some embodiments, the first set of data fields include live fields. In certain embodiments, the second set of data fields include static fields. In some embodiments, the first set of data fields include one or more built-in fields. In certain embodiments, the second set of data fields include one or more built-in fields.

For example, the observation has the following data structure, as an example observation schema (e.g., an example observation specification):
sourceSystemId #ID (identifier) of the source system where the data came from, defined when setting up an integration
collectionId #ID for the collection within a source system, defined when setting up an integration
observationSpecId #ID for this Observation schema
gid #global ID for the track, created automatically when data is integrated
seriesId #an integrator-defined stable ID that refers to a track over time
position #the location of the observation
timestamp #when the Observation took place
expirationTimestamp #calculated automatically from timestamp+TTL (time-to-live): the timestamp at which the observation is no longer considered “live” or active style #styling information to be used by the front-end
optional<entityId>#user-defined ID that refers to the entity represented by the observation (resolvable across tracks)
optional<ttl> #if present, the Observation uses this value for TTL; if ab sent, the Observation uses TTL set in the integration config
acl #the ACL (access control list) for a track in the track level security mode; ignored in the default/integration security mode
set<liveFields> #configurable data in the system that varies over time; see below for a description
set<staticFields> #configurable data in the system that does not over time; see below for a description

According to some embodiments, a field in the system is a key-value pair of a name and a typed value. For example, an entity's speed may have field name “speed” and field value of type double. In certain embodiments, a “live field” (e.g., liveFields) is expected to update with each observation in a track. Examples may include speed or heading. In some embodiments, for each timestamp on a track, the system stores the value of that live field. In certain embodiments, a “static field” is not expected to update with each observation in a track. Examples may include a plane's tail number or a ship's callsign. In some embodiments, the system stores the most recent value of a static property. In certain embodiments, the choice of live and static fields, along with their names and types, is configurable in an observation specification, also referred to as an observation schema.

According to certain embodiments, each field in an observation field can be configured with a certain trait (e.g., configuration), indicating how frontends should display the field. For example, there are three or more types of field traits:
FEATURED: This field is prioritized in displays and search fields. This trait does not affect the backend data store or queries to the system.
DEPRECATED: This field is deprecated, and as such is hidden from displays and search fields. This trait does NOT affect the backend data store or queries to the system.
HIDDEN_FROM_HISTOGRAM: This field is not included in histogram queries.
For example, recommended for fields with a large number of unique values, which do not result in useful histograms.

According to some embodiments, a track is identified by a GID (e.g., global ID). For example, a GID includes track.<sourceSystemId>.<collectionId>.<observationSpecId>. <seriesId>. In certain embodiments, the GID does not include entityId is not included. In some examples, this is different compared to traditional integrations, where tracks were identified by the unique (seriesId, entityId) pair.

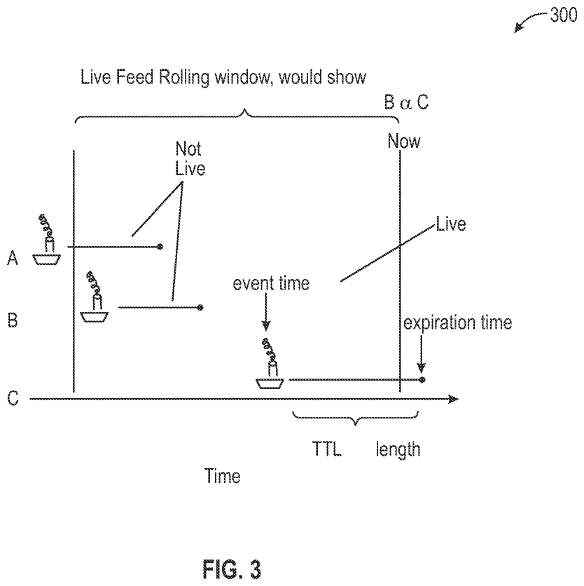

According to certain embodiments, liveness is a special property that is a combination of when an observation took place (event time); and/or a time-to-live (TTL) time set by the data integrator. FIG. 3 illustrates an example diagram 300 for entities A, B, and C. In the example illustrated in FIG. 3, at current time “now”, only ship C is considered Live, per its event time and the assigned expiration time on integration.

In some embodiments, the system can define a window of time for entities that will continue to update in the future. In certain embodiments, the window of time (e.g., rolling window length) means that the layer will include any data that was live in the past. In some embodiments, this is done via a range query on the expirationTimestamp field for the latest observation in a track.

According to certain embodiments, referring back to FIG. 1, data is integrated into the system 100 via a record extractor, which transforms source data into a desired data format that is then formatted into observations (e.g., using observation schemas) to be streamed to the system 100, for example, using an observation schema. In some embodiments, record extractor plugins run within a service (e.g., a geotemporal integration engine (GIE)). In certain embodiments, a plugin, also referred to as a software plugin, refers to a software component that adds a specific feature, for example, retrieving data from a data source. In some embodiments, a plugin includes program codes, when executed in a runtime environment, to perform a function to realize the specific feature. In certain embodiments, the GIE supports existing plugins. In some embodiments, the GIE also supports running plugins that are shipped as assets that are packaged from code that lives in exclusive or air-gapped environments. In certain embodiments, the system 100 and/or the GIE supports one or more plugins dynamically loaded and run by a GIE service.

According to some embodiments, the system 100 includes querying integrations. In certain embodiments, once data (e.g., geotemporal data) is received, stored, and/or processed in the system 100, at least two mechanisms through which data can be retrieved via one or more communication layers. In some embodiments, the one or more communication layers include one or more non-vectorized layers (e.g., duplex communication channels, websockets) and one or more vectorized layers.

According to certain embodiments, the one or more non-vectorized layers stream every observation coming from the integration to the client and aim to have low latency (e.g., sub-second latency). In some embodiments, the system 100 should use the one or more non-vectorized layers when the data source has low-cardinality (e.g., 10-100 unique tracks), fast-updating data where smooth updates to data (e.g., updates on a map) are important (e.g., assets flying). In certain embodiments, the system 100 should avoid using non-vectorized layers for high-cardinality or slowly-updating integrations (e.g., detecting vegetation in satellite imagery. In some embodiments, the non-vectorized layers allow data to flow through the system 100 at the lowest possible latency.

According to some embodiments, the one or more vectorized layers query a snapshot of the most recent observation and encode them in a vectorized format for a compact data representation, for example, as one or more vector tiles. In certain embodiments, the one or more vectorized layers can support layers containing a large number of observations (e.g., millions of observations) and should be used with high-cardinality and/or slowly-updating integrations (e.g., detecting vegetation in satellite imagery, AIS (automated identification system)). In some embodiments, the system 100 should avoid vector tiles when streaming updates to data (e.g., updates to map) is important (e.g., intelligence systems), since vector tiles update slowly. For example, vector tiles update every 4 seconds at quickest, and every 10 minutes at slowest. In certain embodiments, vector tiles are supported by queries to a search engine (e.g., Elasticsearch). In some examples, data is written into the search engine after applying a down sampling window (e.g., every 30 seconds), and tracks encoded in vector tiles can update at the sampling frequency (e.g., once every 30 seconds) or at a maximum frequency of the sampling frequency.

According to certain embodiments, the system 100 may be exposed to client systems via one or more live layers, which may include, for example, subscriptions, feeds, or enterprise map layers (EMLs), and/or the like. In some embodiments, these can be configured in an administrative application. In certain embodiments, only feeds with data that the user has access to will show up. In some embodiments, one or more feeds can contain multiple observation specifications within them. In some embodiments, if a feed includes observations A and B that matches integrations A and B, but the user only has access to A, the user will still see the feed, but it will only contain data from integration A. In certain embodiments, one or more feeds are always filtered to only contain data the user can see, even if the feed's query itself matches more data. In some embodiments, the system 100 refreshes the list of feeds periodically and/or by a trigger. For example, the system 100 refreshes the list of feeds from the administrative application every minute.

According to some embodiments, the system 100 queries a search engine (e.g., Elasticsearch). In certain embodiments, for every geo-temporal-backed data integration, the system 100 creates multiple search indices (e.g., Elasticsearch indices) to store the data in. For example, one stack can have hundreds, sometimes thousands, of indices. In some embodiments, to query the search engine, the system 100 specifies which indices the search engine should look at for the requested data. In certain embodiments, this can make queries more efficient, and it also addresses the fact that different indices may have different fields. For example, a BAS index and an ISR index have very different schemas.

According to certain embodiments, when the system 100 receives a query, it analyzes the query and determines which observation specifications could match the query. For example, the system may use heuristics like “Does this specification have the fields requested?” or “Does the query mention a particular observation specification?”. In some embodiments, the system 100 may select and/or expand the matching observation specifications into the search indices to search.

According to some embodiments, the system 100 can provide one or more alerts on geotemporal data. In certain embodiments, a geotemporal alert is a query on geotemporal data that notifies users as soon as the query becomes true (e.g., when the alert “fires”). In some embodiments, geotemporal alerting workflows are managed on a configuration user interface (UI). For example, users can configure the alert's backing query (e.g., “alert when AIS data enters the Mediterranean Sea”). As an example, users can configure the query by clicking on a map to represent a geofenced region like the Mediterranean Sea (or any arbitrary shape). In this example, in the same UI, users can configure the alert's notifications. In certain embodiments, this attains low latency by running queries on geotemporal data upstream of the search engine, for example, in a search job.

According to certain embodiments, the system 100 may include one or more types of alerts. In some embodiments, one type of alert is an entity state change alert, which is a type of alert indicating if geotemporal tracks flip from matching the alert query (or a list of queries, which are OR-ed with each other) to not matching, or vice versa. For example, “Fire an alert if AIS track with series ID F leaves the Mediterranean Sea.”

In certain embodiments, one type of alert is a count timestamp alert, which is a type of alert indicating if the number of observations matching the alert query meets a configurable threshold during a fixed time interval. For example, “Fire an alert if more than 10,000 AIS observations enter the Mediterranean Sea between 10:00Z and 12:00Z.”

In some embodiments, one type of alert is a multi-linked entity distance alert, which is a type of alert indicating if all query conditions are satisfied by a set of observations within a given distance of another observation (as defined by another observation query). For example, “Fire an alert if AIS track with series ID F and an ADS-B track with series ID A111 both come within 500 meters of AIS track with series ID B.”

In certain embodiments, one type of alert is a linked entity distance alert, which is a special case of multi-linked entity distance alerts, but only supporting one type of track. For example: “Fire an alert if AIS track with series ID F comes within 500 meters of AIS track with series ID B.”

In some embodiments, one type of alert is a multi-threshold alert, which is a type of alerts indicating if the number of observations (possibly of multiple types) matching the alert query meets a configurable threshold over a sliding time window. This is not to be confused with a count timestamp alert, which is over a fixed time interval. For example: “Fire an alert if more than 10,000 AIS observations and more than 1,000 ADS-B observations enter the Mediterranean Sea in any 60-minute sliding time window.”

In certain embodiments, one type of alert is a threshold alert, which is a special case of multi-threshold alerts, but only supporting one type of track. For example: “Fire an alert if more than 10,000 AIS observations enter the Mediterranean Sea in any 60-minute sliding time window.”

According to some embodiments, the system 100 allows administering integrations. In certain embodiments, integrations are administered from their corresponding source system specification. For example, one or more of the following features of integration can be configured:
Retention (retentionDays): the amount of time for which to retain data from an integration
Index Rollover Period for the search engine (rolloverDays): the period of time you keep per historical ES index
Time-to-Live (ttlMillis): the defined time by which an integrated observation from this integration is considered “active” or “live”
Dedupe Parameters (dedupeTicks): the parameters used to decide two successive data points from integration are the same (or close enough where it's only needed to save one, which is useful for integrations that send many data points per second) ACL (acl): a security level that can be set at the collection or source system level.
This sets the required classification and group membership needed to access data from an integration. In certain cases, the system allows for ACLs to be set on the individual track.
Monitors (monitors): configuration for monitors to alert on configured criteria.

In some embodiments, data from each source system is divided into collections, which are integrator-defined subsets of data in a source system (e.g., classified buckets of data and unclassified buckets of data from the same source). In certain embodiments, within each collection, an optional configuration can be specified per observation specification expected in the integration with one or more of the above settings.

In certain examples, retentionDays specifies for how many days data will be kept from a given integration. By default, in some examples, this is set to the global, service-level retention length. In some examples, retentionDays set at the integration-level may supersede the service-level setting. In certain examples, retention is based on the time data is integrated, not the timestamp on the data itself.

In some examples, dedupe parameters (e.g., dedupeTicks) are used to reduce the amount of fast-updating, high-volume data saved when a source is sending more data than is analytically valuable for historical analysis. In certain examples, dedupe only happens on successive Observations within the same track, for example, the path of a single plane within an integration, and only affects how much data is saved for history—it does not affect how much data is sent to subscriptions (e.g., websocket-based subscriptions).

In certain examples, ACLs can be set on the Source system or on a collection to describe the security level of data within that Source system or collection. In some examples, when ACL is set, only users who meet the group and classification criteria will be able to see data from the source system or collection. In certain examples, a user must be working within an Investigation or map (or other artifacts) that has its authorization set at or above the ACL of data from the associated source system that they want to see.

In some examples, monitors can be created on the collection level. In certain examples, the system 100 treats a source system specification level monitor as equivalent to setting the monitor on every collection.

According to some embodiments, the system 100 includes one or more security modes. In certain embodiments, the system 100 supports two security models (e.g., modes), which are separate and mutually exclusive: the integration security model (e.g., integration security mode) and the track-level security (TLS) model (e.g., TLS mode). In some embodiments, the integration security model is accessible and can support a significantly higher scale of data. In certain embodiments, in this security model, each observation is secured based on the security of its collection (if available) or the security of its source system specification as a fallback.

In some embodiments, the track-level security model puts a separate ACL (access control list) on every track and allows for significantly greater granularity. In certain embodiments, however, this makes the processing in this security mode slower. In some embodiments, the system 100 implements the security approach at each step of an observation's lifecycle, for example, being indexed, being searched, triggering an alert, and being live-rendered.

According to certain embodiments, the system 100 implements security at index time. In some embodiments, using the integration security model, when an observation is sent to the system, it already contains security-related information. In some examples, using this model, the security of an observation is specified by the (Source System Spec ID, Collection ID) tuple it carries. In certain embodiments, using TLS model, the system 100 causes the observation to carry a configuration (e.g., AclConfig) specifying its security. In some embodiments, if an observation does not carry a configuration in the TLS mode, it is considered globally visible. In certain embodiments, a search engine may use a TLS model.

According to certain embodiments, the system 100 implements security at search time. In some embodiments, the system 100 implements security at alert time. Using the integration security model, in certain embodiments, the system 100 secures an alert criterion based on the intersection of specifications that the subscribers can access. Using the TLS model, in some embodiments, the system 100 creates a proxy token for each subscriber, gets the accessible ACL IDs for each of them, and sets the intersection as the security for the alert criterion.

According to some embodiments, the system 100 implements security at render time. In certain embodiments, feeds are secured on creation time. In some embodiments, feeds are secured either based on a set of integrations or a set of ACL IDs.

According to certain embodiments, the system 100 may implement two or more options for security, for example, configuration-based (e.g., ACLs, groups, classification, etc.) security, and resource-delegating security. In some embodiments, the configuration-based security is specified in the configuration in the source system specification. In certain embodiments, the configuration-based security may follow one or more standard security specifications. In some embodiments, the system 100 specifies security based on the classification. In certain embodiments, the system 100 uses the security of data to avoid maintaining the same data with different securities. In some embodiments, the system 100 may include one or more mandatory nodes used to enforce mandatory requirements and/or one or more discretionary nodes used to enforce group-based security.

According to some embodiments, for the resource-delegating security model, downstream datasets inherit mandatory requirements (e.g., classifications, markings) from upstream data and/or downstream datasets do not inherit discretionary requirements (e.g., read permissions, view permissions). In some embodiments, the system 100 can receive specified security at either the collection level or the source-system level. In certain embodiments, if a collection lacks security specification, the security is inherited from the source system; that is, when present, the collection security takes precedence over source system security.

According to certain embodiments, the system 100 can purge old data on a configurable schedule. In some embodiments, the system 100 can purge old data based on the storage system. In certain embodiments, the system 100 can purge old data by deletion by query. In some embodiments, the system 100 can log events of creating, modifying, and/or loading geotemporal data. In certain embodiments, certain high-volume logging events are excluded by default and may be enabled in configuration if desired. In some embodiments, logging is done using one or more system endpoints (e.g., proxy) of the system 100.

According to some embodiments, the system 100 allows streaming and/or batch ingestion. In certain embodiments, the system 100 supports two pathways to ingest data: the streaming pipeline and the batch pipeline. In some embodiments, both mechanisms will make data searchable and considered for alerting, but may have different purposes for different workloads. In some embodiments, the majority of geotemporal data flows through the streaming pipeline.

According to certain embodiments, the streaming pipeline uses all streaming architecture (e.g., RabitMQ, Apache Flink), enabling fire-and-forget and low-latency ingestion of data. For example, data enters this pipeline through a proxy or an endpoint which clients can sink to via the provided client system. In some embodiments, the streaming pipeline is suited for data with at least one of the following characteristics: high-scale, low-latency, and continuous. For example, ISR data points stream in at 30 or more points a second and are streamed continuously through non-vectorized layers (e.g., websockets) to the front-end so users can see the plane moving in near real-time.

In certain embodiments, due to the nature of streaming data, the system 100 may not store every point that comes in through the streaming pipeline; instead, the track can be down-sampled such that the system 100 does not lose the fidelity of the track. In some embodiments, the system 100 may ignore a point if it's within a threshold time (e.g., 10 seconds) in event time and/or within a threshold distance (e.g., 5 km) of the previous point. In some embodiments, the threshold time and/or the threshold distance can be configured per integration. In certain embodiments, the system 100 may only update the most-recent observation in a track at a pre-determined frequency (e.g., every 30 seconds of processing time). In some embodiments, the predetermined frequency is not configurable.

According to some embodiments, the batch pipeline synchronously sinks data to the system 100 making it slower than the asynchronous and distributed streaming pipeline. In certain embodiments, one or more client systems can sink data using the geotemporal-indexer service. In some embodiments, the batch pipeline is suited for data with at least one of the following characteristics: one-time imports of data, data that comes in batches, data where down-sampling points are unacceptable, data that requires immediate notice of invalidity (e.g., streaming will sink invalid data to a dead letter queue, while the batch pipeline will return the errant data). For example, vegetation detection data comes in batches when a satellite image has been processed and doesn't require low latency delivery of messages, and thus uses the batch pipeline. In some embodiments, since data through the batch pipeline doesn't come in continuously, the batch pipeline does not support real-time streaming of data to the front-end through one or more non-vectorized layers (e.g., websockets), while support vector tiles.

As shown in FIG. 1, the system 100 for streaming, storing, and processing real-time data implements a system and method for one or more dynamic user-defined geotemporal data schemas according to certain embodiments. In some examples, the system and method for one or more dynamic user-defined geotemporal data schemas provide one or more schemas for geotemporal data, wherein the one or more schemas can be edited at runtime. In certain examples, the system and method for one or more dynamic user-defined geotemporal data schemas allow a user to extend one or more built-in fields (e.g., one or more core fields, the one or more core fields including location and/or timestamp, etc.) and then add one or more custom fields (e.g., one or more live fields, one or more structural fields, etc.) for however the user sees fit. For example, the system and method for one or more dynamic user-defined geotemporal data schemas allows creation of one or more data schemas specifically for geotemporal data. As an example, these one or more data schemas can be user-defined at program run-time, providing a high level of flexibility for the user to model data from any kind of sensor and/or device that outputs location data.

According to some embodiments, one or more users use at least one or more dynamic user-defined geotemporal data schemas to integrate and/or use geotemporal data in one or more workflows of the one or more users. For example, in certain operational contexts, location data is the foundation for building situational awareness around the world. As an example, being able to model the location data, secure the location data, see the location data, and/or combine the location data with one or more other data sources is important to at least some users' workflows.

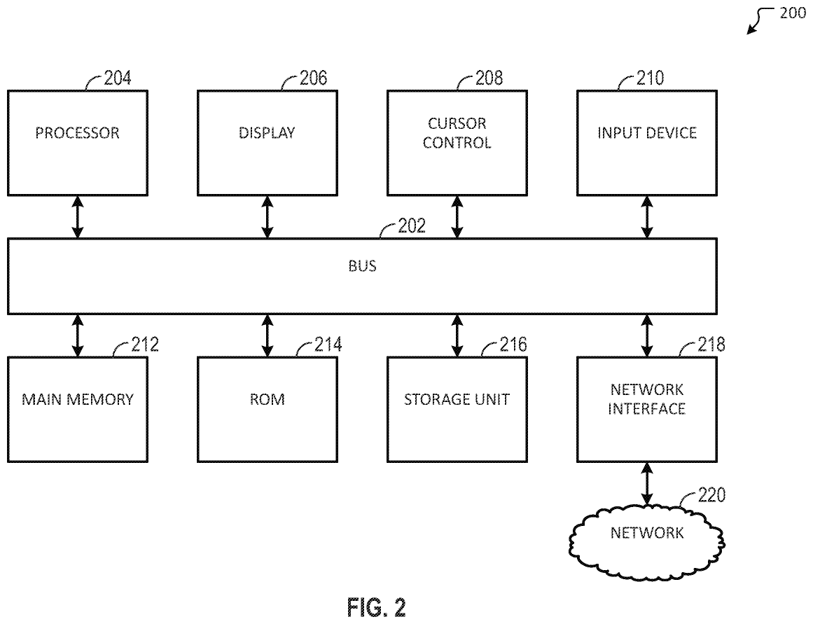

FIG. 2 is a simplified diagram showing a computing system 200 for implementing one or more components or all components of the system 100 for streaming, storing, and processing real-time data in accordance with at least one example set forth in the disclosure. This diagram is merely an example. One of ordinary skill in the art would recognize many variations, alternatives, and modifications.

The computing system 200 includes a bus 202 or other communication mechanism for communicating information, a processor 204, a display 206, a cursor control component 208, an input device 210, a main memory 212, a read only memory (ROM) 214, a storage unit 216, and a network interface 218. In some examples, the bus 202 is coupled to the processor 204, the display 206, the cursor control component 208, the input device 210, the main memory 212, the read only memory (ROM) 214, the storage unit 216, and/or the network interface 218. In certain examples, the network interface 218 is coupled to a network 220. For example, the processor 204 includes one or more general purpose microprocessors. In some examples, the main memory 212 (e.g., random access memory (RAM), cache and/or other dynamic storage devices) is configured to store information and instructions to be executed by the processor 204. In certain examples, the main memory 212 is configured to store temporary variables or other intermediate information during execution of instructions to be executed by processor 204. For examples, the instructions, when stored in the storage unit 216 accessible to processor 204, render the computing system 200 into a special-purpose machine that is customized to perform the operations specified in the instructions. In some examples, the ROM 214 is configured to store static information and instructions for the processor 204. In certain examples, the storage unit 216 (e.g., a magnetic disk, optical disk, or flash drive) is configured to store information and instructions.

In some embodiments, the display 206 (e.g., a cathode ray tube (CRT), an LCD display, or a touch screen) is configured to display information to a user of the computing system 200. In some examples, the input device 210 (e.g., alphanumeric and other keys) is configured to communicate information and commands to the processor 204. For example, the cursor control component 208 (e.g., a mouse, a trackball, or cursor direction keys) is configured to communicate additional information and commands (e.g., to control cursor movements on the display 206) to the processor 204.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

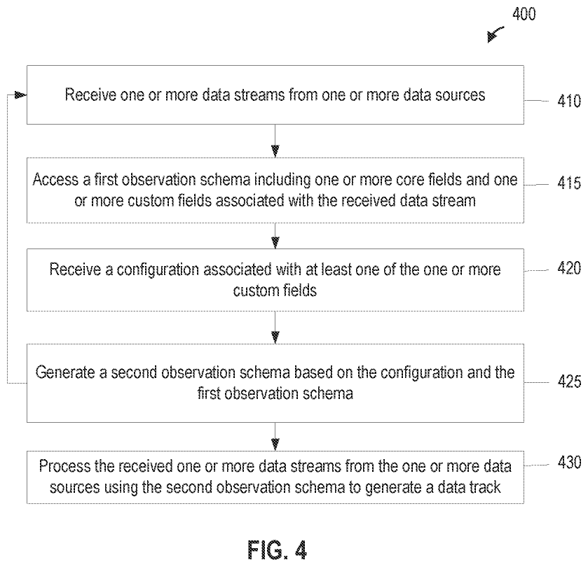

FIG. 4 is a simplified diagram showing a method 400 for generating and/or managing observation schemas according to certain embodiments of the present disclosure. This diagram is merely an example. One of ordinary skill in the art would recognize many variations, alternatives, and modifications. The method 400 for generating and/or managing observation schemas includes processes 410, 415, 420, 425, and 430. Although the above has been shown using a selected group of processes for the method 400 for generating and/or managing observation schemas, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 400 are performed by a system (e.g., the computing system 200). In certain examples, some or all processes (e.g., steps) of the method 400 are performed by a computer and/or a processor directed by a code. For example, a computer includes a server computer and/or a client computer (e.g., a personal computer). In some examples, some or all processes (e.g., steps) of the method 400 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at process 410, the system is configured to receive one or more data streams from one or more data sources. In certain examples, the system identifies the one or more data streams based at least in part on a user input. In some examples, the user input indicates a selection of the one or more data streams. In certain embodiments, the one or more data sources are associated with one or more sensors and/or one or more sensor types. In some examples, the sensor type can include at least one selected from a group consisting of an image sensor, a video sensor (e.g., a video camera), an acoustic sensor, a transducer, an ultrasonic sensor, an infrared sensor, a six degrees of freedom (DoF) sensor, an accelerometer, a gyroscope sensor, an orientation sensor, a position sensor, and/or the like. In certain examples, the one or more data streams include a first data stream from a first data source and a second data stream from a second data source different from the first data source. In some examples, the one or more data streams include a first data stream from a first data source corresponding to a first sensor and a second data stream from a second data source corresponding to a second sensor different from the first sensor. In certain examples, the one or more data streams include a first data stream from a first data source associated with a first sensor type (e.g., data collected by an image sensor) and a second data stream from a second data source associated with a second sensor type (e.g., data collected by an acoustic sensor) different from the first sensor type.

According to certain embodiments, at process 415, the system accesses a first observation schema including one or more built-in fields and one or more custom fields associated with the received data stream. In some embodiments, the system identifies the first observation schema based on the received data stream. In certain embodiments, the system identifies the first observation schema by matching the received data stream with the first observation schema. In some embodiments, the system identifies the first observation schema based on a user input. In certain embodiments, an observation schema includes one or more types of data fields. In some embodiments, the observation schema includes two or more types of data fields. In certain embodiments, the observation schema includes one or more built-in fields (e.g., required fields, core fields, etc.), which exist across two or more observation schemas. In certain examples, the one or more built-in fields include at least one selected from a group consisting of a temporal data field and a geospatial data field.

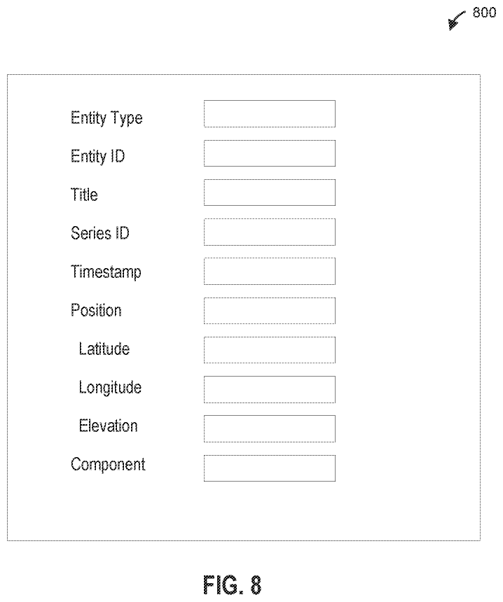

In some embodiments, the observation schema includes one or more live fields, for example, to capture data updates at a relatively high data rate. In certain embodiments, the observation schema includes one or more static fields, for example, to capture data that does not update or data that updates at a relatively low data rate. In some embodiments, the observation schema includes one or more custom fields, for example, data fields can be added, deleted, modified, and/or managed at runtime. In certain embodiments, the observation schema includes one or more custom fields, for example, data fields can be added, deleted, modified, and/or managed at runtime via a user interface (e.g., the user interface illustrated in FIG. 8). In some embodiments, at least one of the one or more custom fields includes a live field corresponding to data updating at a first data rate, wherein at least one of the one or more custom fields includes a static field corresponding to date updating at a second data rate, wherein the first data rate is higher than the second data rate.

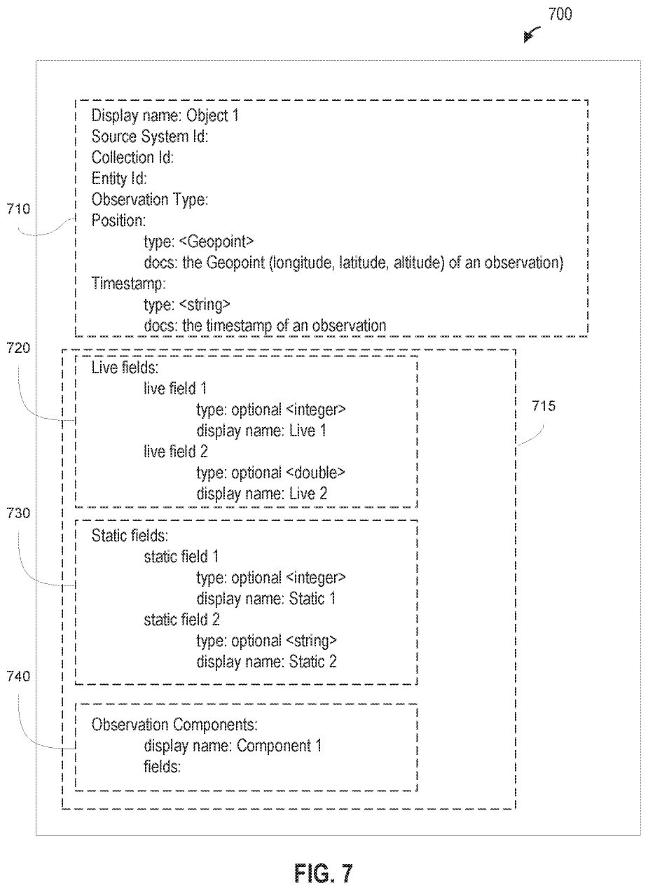

FIG. 7 illustrates an example observation schema 700, including one or more built-in fields 710 and one or more custom fields 715. In some embodiments, the one or more custom fields include one or more live fields 720, one or more static fields 730, and/or one or more other observation components 740. In certain embodiments, a data field, also referred to as a field, is a key-value pair of a name and a typed value. In some embodiments, a data field includes one or more metadata (e.g., data size, data type, display name, etc.). In certain embodiments, a data field includes metadata indicating a data type. In some embodiments, each built-in field of the one or more built-in fields includes the metadata specifying the data type. In some embodiments, a data field includes metadata associated with presentation (e.g., display name, display color, display size, etc.). In certain embodiments, the one or more built-in fields 710 include one or more static fields for data updating at a relatively low data rate or not updating. In some embodiments, the one or more built-in fields 710 include one or more live fields for data updating at a relatively high data rate. In certain embodiments, only live fields include historical data, such that the storage space is reduced.

According to some embodiments, at process 420, the system receives a configuration associated with at least one of the one or more custom fields. In certain embodiments, the configuration is received by an interface (e.g., a user interface, a software interface). In some embodiments, the system receives and/or accesses a selected observation schema based on user inputs. FIG. 8 illustrates an example user interface 800 allows a user to configure and/or select an observation schema, according to certain embodiments of the present disclosure. In certain embodiments, the system identifies the observation schema via data received via a software interface and/or a software plugin.

According to certain embodiments, at process 425, the system generates a second observation schema based on the configuration and the first observation schema. In some embodiments, the system generates the second observation schema while the first observation schema is in use, where the first observation schema is a first version of an observation schema and the second observation schema is a second version of the observation schema.

According to certain embodiments, the system generates the second observation schema using a machine learning model, for example, automatically generating the second observation schema. In some embodiments, the system generates the second observation schema via applying a machine learning model to the received data stream and the identified first observation schema. In certain embodiments, the machine learning model includes a language model. In some embodiments, the machine learning model includes a large language model. In certain embodiments, the system generates a prompt using data in the received data stream and provides the prompt to the LLM to generate the second observation schema. In some embodiments, the machine learning model is trained using historical prompts including observation schema features and historical observation schemas.

According to some embodiments, the system may go back to process 410 to generate additional observation schemas based on additional data streams. In certain embodiments, the system receives a second data stream from the one or more data sources. In some embodiments, the system receives a second configuration of at least one of the one or more custom fields. In certain embodiments, the system generates a third observation schema based on the second configuration and the first observation schema, where the third observation schema is different from the second observation schema.

According to certain embodiments, the system applies a first data transformation to the first data stream to generate a transformed first data stream, where the system generates the second observation schema based at least in part on the transformed first data stream. In some embodiments, the system applies a second data transformation to the second data stream to generate a transformed second data stream, where the system generates the third observation schema based at least in part on the transformed second data stream. In certain embodiments, at least a part of or all of the built-in fields are strongly typed. In some embodiments, the system determines the data type for a built-in field and converts data from the received data stream according to the data type. In certain embodiments, the data transformation includes at least one selected from a group of data extraction, data conversion, data modification, and/or the like. In some embodiments, the one or more built-in fields include a temporal data field of a specific time format (e.g., ISO 8601). In certain embodiments, the one or more built-in fields include a geospatial data field of a specific geospatial format.

According to some embodiments, at process 430, the system processes the received one or more data streams from the one or more data sources using the second observation schema and/or other observations schemas to generate a data track, where the data track includes a plurality of observations. In certain embodiments, each observation of the plurality of observations is generated using the observation schema. In some embodiments, one data stream is corresponding to one observation schema. In certain embodiments, the data track includes a plurality of observations. In some embodiments, a part of the plurality of observations includes one or more live fields. In certain embodiments, the second observation schema includes one or more static fields and one or more live fields. In some embodiments, the plurality of observations including a set of first observations and a set of second observations, where each first observation in the set of first observation includes at least one of the one or more static fields, where each second observation in the set of second observations does not include the at least one of the one or more static fields. In certain embodiments, each second observation in the set of second observations includes only the one or more live fields. In some embodiments, each second observation in the set of second observations does not include any static fields. In certain embodiments, each first observation includes a first set of data fields and each second observation includes a second set of data fields, wherein the first set of data fields are different from the second set of data fields.

According to certain embodiments, the one or more data sources include data from a plurality of sensors and/or a plurality of sensor types. In some embodiments, the data stream includes a first data stream corresponding to a first sensor type of the plurality of sensor types and a second data stream corresponding to a second sensor type of the plurality of sensor types. In certain embodiments, the system generates the second observation schema based on the first data stream. In some embodiments, the system generates a third observation schema based on the second data stream, where the third observation schema is different from the second observation schema, the third observation schema including one or more built-in fields that are included in the second observation schema. In certain embodiments, the third observation schema includes at least one custom field that is not in the second observation schema.

According to some embodiments, the system generates a plurality of first observations based on the first data stream using the second observation schema and generates a plurality of second observations based on the second data stream using the third observation schema. In certain embodiments, the system aggregates the plurality of first observations and the plurality of second observations based at least in part on the one or more built-in fields. In some embodiments, the system presents the aggregated observations. In certain embodiments, the system aggregates the plurality of first observations and the plurality of second observations based at least in part on metadata in the data fields. In some examples, at least one data field in the plurality of first observations is not used in the data aggregation. In certain examples, at least one data field in the plurality of second observations is not used in the data aggregation. In some embodiments, the system presents the aggregated observations based at least in part on metadata in the data fields.

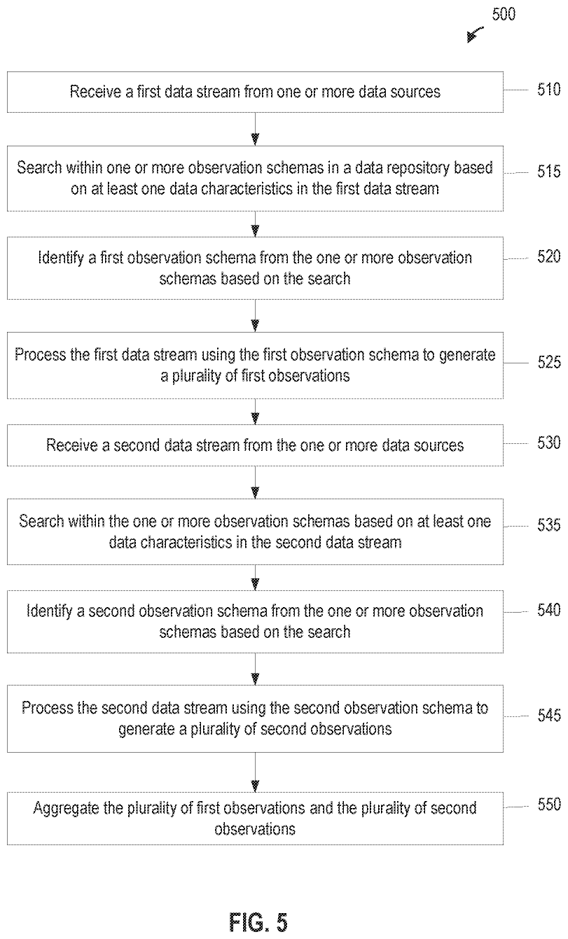

FIG. 5 is a simplified diagram showing a method 500 for managing and/or using observation schemas according to certain embodiments of the present disclosure. This diagram is merely an example. One of ordinary skill in the art would recognize many variations, alternatives, and modifications. The method 500 for managing and/or using observation schemas includes processes 510, 515, 520, 525, 530, 535, 540, 545, and 550. Although the above has been shown using a selected group of processes for the method 500 for managing and/or using observation schemas, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 500 are performed by a system (e.g., the computing system 200). In certain examples, some or all processes (e.g., steps) of the method 500 are performed by a computer and/or a processor directed by a code. For example, a computer includes a server computer and/or a client computer (e.g., a personal computer). In some examples, some or all processes (e.g., steps) of the method 500 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

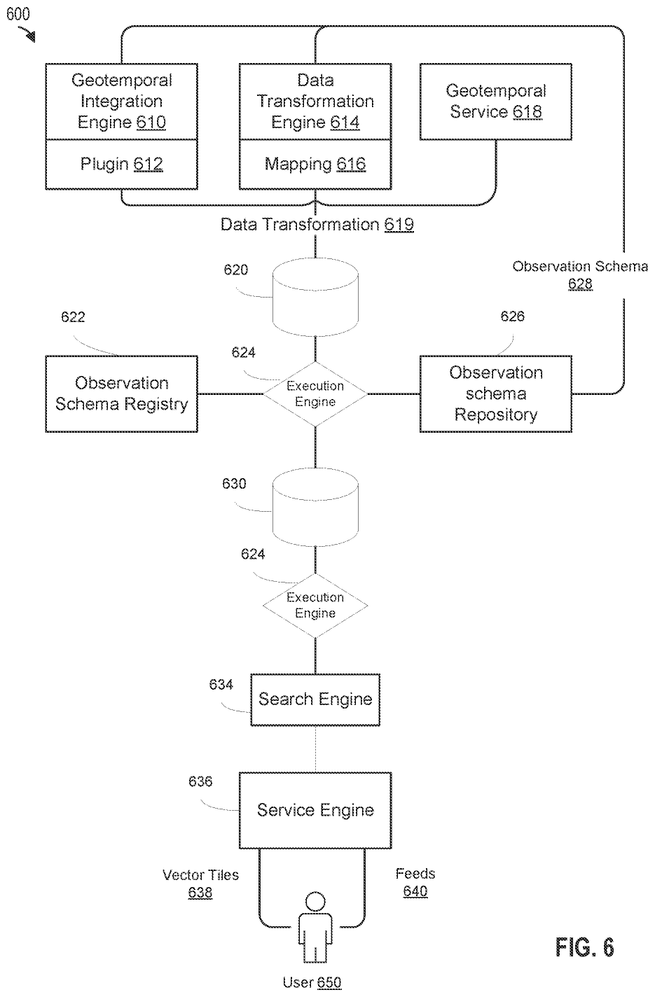

According to some embodiments, at process 510, the system receives a first data stream from one or more data sources. In certain embodiments, at process 515, the system searches within one or more observation schemas in a data repository (e.g., the observation schema repository 626 in FIG. 6) based on at least one data characteristics in the first data stream. In some examples, the data characteristic includes at least one selected from a group consisting of a sensor type, an entity type (e.g., an object type, a plane, a ship, etc.), an update frequency, an expiration time, and/or the like. In some embodiments, the system identifies a first observation schema from the one or more observation schemas based on the search. In certain embodiments, at process 525, the system processes the first data stream using the first observation schema to generate a plurality of first observations. In some embodiments, the plurality of first observations include a first subset of observations and a second subset of observations, where the first subset has a plurality of data fields different from the second subset.

According to certain embodiments, at process 530, the system receives a second data stream from the one or more data sources. In certain embodiments, at process 535, the system searches within one or more observation schemas based on at least one data characteristics in the second data stream. In some embodiments, the system identifies a second observation schema from the one or more observation schemas based on the search. In certain embodiments, at process 545, the system processes the second data stream using the second observation schema to generate a plurality of second observations. In some embodiments, the first observation schema and the second observation schema include at least a part or all of same built-in fields. In certain embodiments, the first built-in fields in the first observation schema and the second built-in fields in the second observation schema have same data types.

In certain embodiments, the built-in fields include the temporal data field and/or the geospatial data field. In some embodiments, the temporal data field in the first observation schema has the same time format as the temporal data field in the second observation schema. In certain embodiments, the geospatial data field in the first observation schema has the same geospatial data format as the geospatial data field in the second observation schema.

According to some embodiments, the system aggregates the plurality of first observations and the plurality of second observations based at least in part on the one or more built-in fields. In some embodiments, the system presents the aggregated observations. In certain embodiments, the system aggregates the plurality of first observations and the plurality of second observations based at least in part on metadata in the data fields. In some examples, at least one data field in the plurality of first observations is not used in the data aggregation. In certain examples, at least one data field in the plurality of first observations is not used in the data aggregation. In some embodiments, the system presents the aggregated observations based at least in part on metadata in the data fields.

FIG. 6 is an illustrative example of a software architecture and/or a software system 600 for generating, using, and/or managing observation schemas, according to certain embodiments of the present disclosure. FIG. 6 is merely an example. One of the ordinary skilled in the art would recognize many variations, alternatives, and modifications. According to certain embodiments, the software architecture and/or system 600 includes a geotemporal integration engine (GIE) 610, a data transformation engine 614, one or more geotemporal services 618, one or more data repositories 620, an observation schema registry 622, one or more execution engines 624, one or more observation schema repositories 626, one or more data repositories 630, a search engine 634, and/or a service engine 636. In certain embodiments, one or more components of the software system 600 are included in the one or more computing devices.

Although the above has been shown using a selected group of components in the software system 600, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

According to certain embodiments, the geotemporal integration engine 610, the data transformation engine 614, and the geotemporal services 618 receive data from one or more data sources. In some embodiments, the data sources are corresponding to data collected in one or more sensors and/or one or more sensor types. In certain examples, the sensor type can include at least one selected from a group consisting of an image sensor, a video sensor (e.g., a video camera), an acoustic sensor, a transducer, an ultrasonic sensor, an infrared sensor, a six degrees of freedom (DoF) sensor, an accelerometer, a gyroscope sensor, an orientation sensor, a position sensor, and/or the like.

In some embodiments, the geotemporal integration engine 610 is coupled with a software plugin 612. In certain embodiments, a plugin, also referred to as a software plugin, refers to a software component that adds a specific feature, for example, retrieving data from a data source. In some embodiments, a plugin includes program codes, when executed in a runtime environment, to perform a function to realize the specific feature. In certain embodiments, the software plugin 612 includes a definition of an observation schema. In some embodiments, the software plugin 612 can be configured to select an observation schema. In certain embodiments, the geotemporal integration engine 610 receives and/or accesses one or more observation schemas 628, for example, from the one or more observation schema repository 626. In some embodiments, the geotemporal integration engine 610 receives and/or accesses a selected observation schema 628 based on input and/or configuration from the software plugin 612. In certain embodiments, the software plugin 612 is integrated into the geotemporal integration engine 610.

According to some embodiments, the software plugin 612 performs data transformation 619 to one or more data streams received from the corresponding data sources based on the at least one of the one or more observation schemas 628. In certain embodiments, the software plugin 612 generates one or more observations (e.g., data for an event at a time and/or geospatial location). In some embodiments, the software plugin 612 stores the generated observations to the one or more data repositories 620.

According to some embodiments, an observation refers to an event at a time and/or geospatial location (e.g., place). In certain embodiments, an observation refers to an event at a time and geospatial location (e.g., a place, a GPS (global position system) ping). In certain embodiments, a track, also referred to as a data track, refers to a time series of observations from the same source (e.g., the history of places that a shark wearing a GPS tag has been). In some examples, observations are schematized according to observation schemas. In certain embodiments, observations are captured as data objects using the observation schemas.

According to certain embodiments, the observation schema 628 includes one or more types of data fields. In some embodiments, the observation schema 628 includes two or more types of data fields. In certain embodiments, the observation schema 628 includes one or more built-in fields (e.g., required fields, core fields, etc.), which exist across two or more observation schemas. In certain examples, the one or more built-in fields include at least one selected from a group consisting of a temporal data field and a geospatial data field. In some embodiments, the observation schema 628 includes one or more live fields, for example, to capture data updates at a relatively high data rate. In certain embodiments, the observation schema 628 includes one or more static fields, for example, to capture data that does not update or data updates at a relatively low data rate. In some embodiments, the observation schema 628 includes one or more custom fields, for example, data fields can be added, deleted, modified, and/or managed at runtime.

FIG. 7 illustrates an example observation schema 700, including one or more built-in fields 710 and one or more custom fields 715. In some embodiments, the one or more custom fields include one or more live fields 720, one or more static fields 730, and/or one or more other observation components 740. In certain embodiments, a data field, also referred to as a field, is a key-value pair of a name and a typed value. In some embodiments, a data field includes one or more metadata (e.g., data size, data type, display name, etc.). In certain embodiments, a data field includes metadata indicating a data type. In some embodiments, each built-in field of the one or more built-in fields includes the metadata specifying the data type. In some embodiments, a data field includes metadata associated with presentation (e.g., display name, display color, display size, etc.). In certain embodiments, the one or more built-in fields 710 include one or more static fields for data updating at a relatively low data rate or not updating. In some embodiments, the one or more built-in fields 710 include one or more live fields for data updating at a relatively high data rate. In certain embodiments, only live fields include historical data, such that the storage space is reduced.

In some embodiments, observations are captured as data objects using the observation schemas, where a plurality of first observations including a first set of data fields update at a first data rate (e.g., every one second) and a plurality of second observations including a second set of data fields at a second data rate (e.g., every one hour), where the first data rate is different from the second date rate. In certain embodiments, observations are captured as data objects using the observation schemas, where a plurality of first observations including a first set of data fields update at a first data rate (e.g., every one second) and a plurality of second observations including a second set of data fields at a second data rate (e.g., every one hour), where the first data rate is higher than the second date rate. In certain embodiments, the first set of data fields is a subset of the second set of data fields. In some embodiments, the first set of data fields include live fields. In certain embodiments, the second set of data fields include static fields. In some embodiments, the first set of data fields include one or more built-in fields. In certain embodiments, the second set of data fields include one or more built-in fields.

For example, an entity's speed may have field name “speed” and field value of type double. In certain embodiments, a live field (e.g., liveFields) is expected to update with each observation in a track. Examples may include speed or heading. In some embodiments, for each timestamp on a track, the system stores the value of that live field. In certain embodiments, a static field is not expected to update with each observation in a track. Examples of static fields may include a plane's tail number or a ship's callsign. In some embodiments, the system 600 stores the most recent value of a static field. In certain embodiments, the choice of live and static fields, along with their names and types, is configurable in the observation schema (e.g., the observation specification).

According to certain embodiments, a data field in the observation schema 628 can be configured with certain characteristics (e.g., configuration), indicating how frontends should display the field. In some embodiments, the characteristics of the data field are specified as metadata. For example, there are three or more types of field characteristics:
FEATURED: This field is prioritized in displays and search fields. This trait does not affect the backend data store or queries to the system.
DEPRECATED: This field is deprecated, and as such is hidden from displays and search fields. This trait does NOT affect the backend data store or queries to the system.
HIDDEN: This field is not included in queries (e.g., historical data queries). For example, recommended for fields with a large number of unique values, which do not result in useful histograms.

According to some embodiments, a track is identified by a GID (e.g., global ID). For example, a GID includes track<sourceSystemId>.<collectionId>.<observationSpecId>. <seriesId>. In certain embodiments, the GID does not include entityId is not included. In some examples, this is different compared to traditional integrations, where tracks were identified by the unique (seriesId, entityId) pair.

According to certain embodiments, referring back to FIG. 6, the data transformation engine 614 interfaces one or more software systems (e.g., data sources) to retrieve, receive, and/or access data streams. In some embodiments, the data transformation engine 614 is configured to specify one or more data streams to receive. In certain embodiments, the data transformation engine 614 is integrated with the data mapping 616 (e.g., a mapping plugin) to perform data transformation 619 to the received one or more data streams. In some embodiments, the data transformation engine 614 can run jobs and/or request job runs at the one or more software systems. In certain embodiments, the data transformation engine 614 receives and/or accesses one or more observation schemas 628, for example, from the one or more observation schema repository 626. In some embodiments, the data transformation engine 614 receives and/or accesses a selected observation schema 628 based on user inputs. FIG. 8 illustrates an example user interface 800 allows a user to configure and/or select an observation schema.

According to some embodiments, the data transformation engine 614 performs data transformation 619 to one or more data streams received from the corresponding data sources based on the at least one of the one or more observation schemas 628. In certain embodiments, the data transformation engine 614 generates one or more observations (e.g., data for an event at a time and/or geospatial location). In some embodiments, the data transformation engine 614 stores the generated observations to the one or more data repositories 620.

According to certain embodiments, the geotemporal services 618 can perform data transformation 619 to write a plurality of observations to the one or more data repositories 620. In some embodiments, the system 600 can define a window of time for entities that will continue to update in the future. In certain embodiments, the window of time (e.g., rolling window length) means that the layer will include any data that was live in the past. In some embodiments, this is done via a range query on the expirationTimestamp field for the latest observation in a track.

According to certain embodiments, data is integrated into the system 600 via a record extractor (e.g., the geotemporal integration engine 610, the data transformation engine 614, etc.), which transforms source data into a desired data format that is then formatted into observations to be streamed to the system 600, for example, using an observation schema. In some embodiments, record extractor plugins (e.g., the software plugin 612) run within a service (e.g., the geotemporal integration engine (GIE) 610). In certain embodiments, the GIE 610 supports existing plugins 612. In some embodiments, the GIE 610 also supports running plugins 612 that are shipped as assets that are packaged from code that lives in exclusive or air-gapped environments. In certain embodiments, the system 100 and/or the GIE supports one or more plugins dynamically loaded and run by a GIE service.

According to certain embodiments, the system 600 and/or the data transformation engine 614 receives a configuration via an interface (e.g., a user interface, a software interface) related to an observation schema. In some embodiments, the execution engine 624 can determine the observation schema 628 from the observation schema repository 626. In certain embodiments, if the observation schema 628 is not found in the observation schema repository 626, the execution engine 624 adds a registry to the observation schema registry 622, for example, to link the observation schema with certain data characteristics.

According to some embodiments, the system 600 includes the observation schema registry 622 for matching data streams with observation schemas. In certain embodiments, the observation schema registry 622 allows updates to observation schemas. In some embodiments, the observation schema registry 622 is hosted in the geotemporal service 618. In certain embodiments, the execution engine 624 can perform data validation and store validated data to the one or more data repositories 630. In certain embodiments, the execution engine 624 can perform validation to observations and store the validated observations to the one or more data repositories 630. In some embodiments, the execution engine 624 can provide validated data to the search engine 634.

According to some embodiments, the system 600 is configured to receive one or more data streams from one or more data sources. In certain examples, the system identifies the one or more data streams based at least in part on a user input. In some examples, the user input indicates a selection of the one or more data streams. In certain embodiments, the one or more data sources are associated with one or more sensors and/or one or more sensor types. In some examples, the sensor type can include at least one selected from a group consisting of an image sensor, a video sensor (e.g., a video camera), an acoustic sensor, a transducer, an ultrasonic sensor, an infrared sensor, a six degrees of freedom (DoF) sensor, an accelerometer, a gyroscope sensor, an orientation sensor, a position sensor, and/or the like. In certain examples, the one or more data streams include a first data stream from a first data source and a second data stream from a second data source different from the first data source. In some examples, the one or more data streams include a first data stream from a first data source corresponding to a first sensor and a second data stream from a second data source corresponding to a second sensor different from the first sensor. In certain examples, the one or more data streams include a first data stream from a first data source associated with a first sensor type (e.g., data collected by an image sensor) and a second data stream from a second data source associated with a second sensor type (e.g., data collected by an acoustic sensor) different from the first sensor type.

According to certain embodiments, the system 600 accesses a first observation schema including one or more built-in fields and one or more custom fields associated with the received data stream. In some embodiments, the system 600 identifies the first observation schema based on the received data stream. In certain embodiments, the system 600 identifies the first observation schema by matching the received data stream with the first observation schema. In some embodiments, the system identifies the first observation schema based on a user input.

According to some embodiments, the system 600 receives a configuration associated with at least one of the one or more custom fields. In certain embodiments, the configuration is received by an interface (e.g., a user interface, a software interface). In some embodiments, the system receives and/or accesses a selected observation schema based on user inputs. In certain embodiments, the system identifies the observation schema via data received via a software interface and/or a software plugin.

According to certain embodiments, the system 600 generates a second observation schema based on the configuration and the first observation schema. In some embodiments, the system generates the second observation schema while the first observation schema is in use, where the first observation schema is a first version of an observation schema and the second observation schema is a second version of the observation schema.

According to certain embodiments, the system 600 generates the second observation schema using a machine learning model, for example, automatically generating the second observation schema. In some embodiments, the system generates the second observation schema via applying a machine learning model to the received data stream and the identified first observation schema. In certain embodiments, the machine learning model includes a language model. In some embodiments, the machine learning model includes a large language model. In certain embodiments, the system generates a prompt using data in the received data stream and provides the prompt to the LLM to generate the second observation schema. In some embodiments, the machine learning model is trained using historical prompts including observation schema features and historical observation schemas.

According to some embodiments, the system may go back to generate additional observation schemas based on additional data streams. In certain embodiments, the system receives a second data stream from the one or more data sources. In some embodiments, the system receives a second configuration of at least one of the one or more custom fields. In certain embodiments, the system generates a third observation schema based on the second configuration and the first observation schema, where the third observation schema is different from the second observation schema.

According to certain embodiments, the system 600 applies a first data transformation to the first data stream to generate a transformed first data stream, where the system generates the second observation schema based at least in part on the transformed first data stream. In some embodiments, the system applies a second data transformation to the second data stream to generate a transformed second data stream, where the system generates the third observation schema based at least in part on the transformed second data stream. In certain embodiments, at least a part of or all of the built-in fields are strongly typed. In some embodiments, the system determines the data type for a built-in field and converts data from the received data stream according to the data type. In certain embodiments, the data transformation includes at least one selected from a group of data extraction, data conversion, data modification, and/or the like. In some embodiments, the one or more built-in fields include a temporal data field of a specific time format (e.g., ISO 8601). In certain embodiments, the one or more built-in fields include a geospatial data field of a specific geospatial format.

According to some embodiments, the system 600 processes the received one or more data streams from the one or more data sources using the second observation schema and/or other observations schemas to generate a data track, where the data track includes a plurality of observations. In certain embodiments, each observation of the plurality of observations is generated using the observation schema. In some embodiments, one data stream is corresponding to one observation schemas. In certain embodiments, the data track includes a plurality of observations. In some embodiments, a part of the plurality of observations includes one or more live fields.

In certain embodiments, the second observation schema includes one or more static fields and one or more live fields. In some embodiments, the plurality of observations including a set of first observations and a set of second observations, wherein each first observation in the set of first observation includes at least one of the one or more static fields, wherein each second observation in the set of second observations does not include the least one of the one or more static fields. In certain embodiments, each second observation in the set of second observations includes only the one or more live fields. In some embodiments, each second observation in the set of second observations does not include any static fields. In certain embodiments, each first observation includes a first set of data fields and each second observation includes a second set of data fields, wherein the first set of data fields are different from the second set of data fields.

According to certain embodiments, the one or more data sources include data from a plurality of sensors and/or a plurality of sensor types. In some embodiments, the data stream includes a first data stream corresponding to a first sensor type of the plurality of sensor types and a second data stream corresponding to a second sensor type of the plurality of sensor types. In certain embodiments, the system generates the second observation schema based on the first data stream. In some embodiments, the system generates a third observation schema based on the second data stream, where the third observation schema is different from the second observation schema, the third observation schema including one or more built-in fields that are included in the second observation schema. In certain embodiments, the third observation schema includes at least one custom field that is not in the second observation schema.

According to some embodiments, the system 600 receives a first data stream from one or more data sources. In certain embodiments, the system 600 searches within one or more observation schemas in the observation schema repository 626 based on at least one data characteristics in the first data stream. In some examples, the data characteristic includes at least one selected from a group consisting of a sensor type, an entity type (e.g., an object type, a plane, a ship, etc.), an update frequency, an expiration time, and/or the like. In some embodiments, the system 600 identifies a first observation schema from the one or more observation schemas based on the search. In certain embodiments, the system 600 processes the first data stream using the first observation schema to generate a plurality of first observations.

According to certain embodiments, the system 600 receives a second data stream from the one or more data sources. In certain embodiments, the system 600 searches within one or more observation schemas based on at least one data characteristics in the second data stream. In some embodiments, the system 600 identifies a second observation schema from the one or more observation schemas based on the search. In certain embodiments, the system 600 processes the second data stream using the second observation schema to generate a plurality of second observations. In some embodiments, the first observation schema and the second observation schema include at least a part or all of same built-in fields. In certain embodiments, the first built-in fields in the first observation schema and the second built-in fields in the second observation schema have same data types.

In certain embodiments, the built-in fields include the temporal data field and/or the geospatial data field. In some embodiments, the temporal data field in the first observation schema has the same time format as the temporal data field in the second observation schema. In certain embodiments, the geospatial data field in the first observation schema has the same geospatial data format as the geospatial data field in the second observation schema.

According to some embodiments, the system 600 generates a plurality of first observations based on the first data stream using the second observation schema and generates a plurality of second observations based on the second data stream using the third observation schema. In certain embodiments, the system 600 aggregates the plurality of first observations and the plurality of second observations based at least in part on the one or more built-in fields. In some embodiments, the system 600 presents the aggregated observations. In certain embodiments, the system aggregates the plurality of first observations and the plurality of second observations based at least in part on metadata in the data fields. In some examples, at least one data field in the plurality of first observations is not used in the data aggregation. In certain examples, at least one data field in the plurality of first observations is not used in the data aggregation. In some embodiments, the system presents the aggregated observations based at least in part on metadata in the data fields.

According to some embodiments, the system 600 includes querying and/or searching integrations. In certain embodiments, once data (e.g., geotemporal data) is received, stored, and/or processed in the system 600, at least two mechanisms through which data can be retrieved via one or more communication layers. In some embodiments, the one or more communication layers include one or more non-vectorized layers (e.g., duplex communication channels, websockets) and one or more vectorized layers.

According to certain embodiments, the one or more non-vectorized layers stream every observation coming from the integration to the client and aim to have low latency (e.g., sub-second latency). In some embodiments, the system 600 can use the one or more non-vectorized layers when the data source has low-cardinality (e.g., 10-100 unique tracks), fast-updating data where smooth updates to data (e.g., updates on a map) are important (e.g., assets flying). In certain embodiments, the system 600 may avoid using non-vectorized layers for high-cardinality or slowly-updating integrations (i.e. BAS (building automation system)). In some embodiments, the non-vectorized layers allow data to flow through the system 600 at the lowest possible latency.

According to some embodiments, the one or more vectorized layers may query, via the service engine 636, a snapshot of the most recent observation and/or observations in a time window and generate observations in a vectorized format, for example, one or more vector tiles 638, for a compact data representation. In certain embodiments, the one or more vectorized layers can support layers containing a large number of observations (e.g., millions of observations) and should be used with high-cardinality and/or slowly-updating integrations (e.g., BAS, AIS (automated identification system)). In some embodiments, the system 600 may avoid vector tiles when streaming updates to data (e.g., updates to map) is important (e.g., intelligence systems), since vector tiles update slowly. For example, vector tiles update every 4 seconds at quickest, and every 10 minutes at slowest. In certain embodiments, vector tiles are supported by queries to a search engine (e.g., Elasticsearch). In some examples, data is written into the search engine after applying a down sampling window (e.g., every 30 seconds), and tracks encoded in vector tiles can update at the sampling frequency (e.g., once every 30 seconds) or at a maximum frequency of the sampling frequency.

According to certain embodiments, the system 600 may couple to client systems via one or more interface layers (e.g., the geotemporal integration engine 610, the data transformation engine 614, etc.), which may include, for example, subscriptions, feeds, or enterprise map layers (EMLs), and/or the like. In some embodiments, these can be configured in an administrative application. In certain embodiments, only feeds 640 with data that a user 650 has access to will show up. In some embodiments, one or more feeds can contain multiple observation specifications within them. In some embodiments, if a feed includes observations A and B that matches integrations A and B, but the user only has access to A, the user 650 will still see the feed 640, but it will only contain data from integration A. In certain embodiments, one or more feeds are always filtered to only contain data the user can see, even if the feed's query itself matches more data. In some embodiments, the system 600 refreshes the list of feeds periodically and/or by a trigger. For example, the system 600 refreshes the list of feeds from the administrative application every minute.

According to some embodiments, the system 600 queries a search engine 636 (e.g., Elasticsearch). In certain embodiments, for every geo-temporal-backed data integration, the system 600 creates multiple search indices (e.g., Elasticsearch indices) to store the data in. For example, one stack can have hundreds, sometimes thousands, of indices. In some embodiments, to query the search engine, the system 100 specifies which indices the search engine should look at for the requested data. In certain embodiments, this can make queries more efficient, and it also addresses the fact that different indices may have different fields. For example, a BAS index and an ISR index have very different schemas.

According to certain embodiments, when the system 600 receives a query, it analyzes the query and determines which observation specifications could match the query. For example, the system may use heuristics like “Does this specification have the fields requested?” or “Does the query mention a particular observation specification?”. In some embodiments, the system 600 may select and/or expand the matching observation specifications into the search indices to search.

In some embodiments, the one or more data repositories 620, the one or more data repositories 630, and/or the one or more observation schema repositories 626 can include input data streams, observations, tracks, observation schemas, and/or the like. The one or more data repositories 620, the one or more data repositories 630, and/or the one or more observation schema repositories 626 may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the software system 600 can execute software or firmware stored in non-transitory computer-readable medium to implement various processing steps. Various components and processors of the can be implemented by one or more computing devices including, but not limited to, circuits, a computer, a cloud-based processing unit, a processor, a processing unit, a microprocessor, a mobile computing device, and/or a tablet computer. In some cases, various components of the software system 600 (e.g., the geotemporal integration engine 610, the data transformation engine 614, the geotemporal service 618, the execution engine 624, the search engine 634, the service engine 636, etc.) can be implemented on a shared computing device. Alternatively, a component of the software system 600 can be implemented on multiple computing devices. In some implementations, various modules and components of the software system 600 can be implemented as software, hardware, firmware, or a combination thereof. In some cases, various components of the software system 600 can be implemented in software or firmware executed by a computing device.

Various components of the software system 600 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

According to certain embodiments, a method for managing one or more observation schemas, the method comprising: receiving a data stream from one or more data sources; accessing a first observation schema including one or more built-in fields and one or more custom fields associated with the received data stream; receiving a configuration associated with at least one of the one or more custom fields; and generating a second observation schema based on the configuration and the first observation schema; wherein at least a part of the method is performed using one or more processors. For example, the method is implemented according to at least FIG. 1, FIG. 4, and/or FIG. 6.

In some embodiments, the generating a second observation schema comprises generating the second observation schema while the first observation schema is in use, wherein the first observation schema is a first version of an observation schema and the second observation schema is a second version of the observation schema. In certain embodiments, the one or more built-in fields include at least one selected from a group consisting of a temporal data field and a geospatial data field. In some embodiments, at least one of the one or more custom fields includes a live field corresponding to data updating at a first data rate, wherein at least one of the one or more custom fields includes a static field corresponding to date updating at a second data rate, wherein the first data rate is higher than the second data rate. In certain embodiments, the accessing a first observation schema includes identifying the first observation schema based on a user input.

In some embodiments, the generating a second observation schema includes generating the second observation schema via applying a machine learning model to the received data stream and the first observation schema. In certain embodiments, the machine learning model includes a large language model. In some embodiments, the receiving a data stream includes identifying the data stream by a user input. In certain embodiments, the data stream is a first data stream, the configuration is a first configuration, wherein the method further comprises: receiving a second data stream from the one or more data sources; receiving a second configuration of at least one of the one or more custom fields; and generating a third observation schema based on the second configuration and the first observation schema, the third observation schema being different from the second observation schema.

In certain embodiments, the first data stream is received from a first data source and the second data stream is received from a second data source different from the first data source. In some embodiments, the first data source is associated with a first sensor type and the second data source is associated with a second sensor type different from the first sensor type. In certain embodiments, the method further comprises: applying a first data transformation to the first data stream to generate a transformed first data stream; wherein the generating a second observation schema includes generating the second observation schema based at least in part on the transformed first data stream; applying a second data transformation to the second data stream to generate a transformed second data stream; wherein the generating a third observation schema includes generating the third observation schema based at least in part on the transformed second data stream.

In some embodiments, the method further comprises: processing the data stream from the one or more data sources using the second observation schema to generate a data track, wherein the data track includes a plurality of observations, each observation of the plurality of observations being generated using the second observation schema. In certain embodiments, the second observation schema includes one or more static fields and one or more live fields, wherein the plurality of observations including a set of first observations and a set of second observations, wherein each first observation in the set of first observations includes at least one of the one or more static fields, wherein each second observation in the set of second observations does not include the at least one of the one or more static fields.

In some embodiments, the one or more data sources include data from a plurality of sensor types, wherein the data stream includes a first data stream corresponding to a first sensor type of the plurality of sensor types and a second data stream corresponding to a second sensor type of the plurality of sensor types, wherein the generating a second observation schema includes generating the second observation schema based on the first data stream; wherein the method further comprises: generating a third observation schema based on the second data stream, the third observation schema being different from the second observation schema, the third observation schema including one or more built-in fields that are included in the second observation schema; generating a plurality of first observations based on the first data stream using the second observation schema; generating a plurality of second observations based on the second data stream using the third observation schema; and aggregating the plurality of first observations and the plurality of second observations based at least in part on the one or more built-in fields.

According to certain embodiments, a method for using one or more observation schemas, the method comprising: receiving a data stream from one or more data sources; searching within one or more observation schemas in a data repository based on at least one data characteristics in the data stream; identifying an observation schema from the one or more observation schemas based on the search; and processing the data stream using the identified observation schema to generate a plurality of observations; wherein at least a part of the method is performed using one or more processors. For example, the method is implemented according to at least FIG. 1, FIG. 5, and/or FIG. 6.

In some embodiments, the identified observation schema includes one or more static fields and one or more live fields, wherein the plurality of observations including a set of first observations and a set of second observations, wherein each first observation in the set of first observations includes at least one of the one or more static fields, wherein each second observation in the set of second observations does not include the at least one of the one or more static fields.

In certain embodiments, the one or more data sources include data from a plurality of sensor types, wherein the data stream includes a first data stream corresponding to a first sensor type of the plurality of sensor types and a second data stream corresponding to a second sensor type of the plurality of sensor types, wherein the generating a second observation schema includes generating the second observation schema based on the first data stream; wherein the method further comprises: generating a third observation schema based on the second data stream, the third observation schema being different from the second observation schema, the third observation schema including one or more built-in fields that are included in the second observation schema; generating a plurality of first observations based on the first data stream using the second observation schema; generating a plurality of second observations based on the second data stream using the third observation schema; and aggregating the plurality of first observations and the plurality of second observations based at least in part on the one or more built-in fields.

According to certain embodiments, a system for managing one or more observation schemas, the system comprising: one or more memories having instructions stored thereon; and one or more processors configured to execute the instructions and perform operations comprising: receiving a data stream from one or more data sources; accessing a first observation schema including one or more built-in fields and one or more custom fields associated with the received data stream; receiving a configuration associated with at least one of the one or more custom fields; and generating a second observation schema based on the configuration and the first observation schema. For example, the system is implemented according to at least FIG. 1, FIG. 4, FIG. 5 and/or FIG. 6.

In some embodiments, the generating a second observation schema comprises generating the second observation schema while the first observation schema is in use, wherein the first observation schema is a first version of an observation schema and the second observation schema is a second version of the observation schema. In certain embodiments, the one or more built-in fields include at least one selected from a group consisting of a temporal data field and a geospatial data field. In some embodiments, at least one of the one or more custom fields includes a live field corresponding to data updating at a first data rate, wherein at least one of the one or more custom fields includes a static field corresponding to date updating at a second data rate, wherein the first data rate is higher than the second data rate. In certain embodiments, the accessing a first observation schema includes identifying the first observation schema based on a user input.

In some embodiments, the generating a second observation schema includes generating the second observation schema via applying a machine learning model to the received data stream and the first observation schema. In certain embodiments, the machine learning model includes a large language model. In some embodiments, the receiving a data stream includes identifying the data stream by a user input. In certain embodiments, the data stream is a first data stream, the configuration is a first configuration, wherein the operations further comprise: receiving a second data stream from the one or more data sources; receiving a second configuration of at least one of the one or more custom fields; and generating a third observation schema based on the second configuration and the first observation schema, the third observation schema being different from the second observation schema.

In certain embodiments, the first data stream is received from a first data source and the second data stream is received from a second data source different from the first data source. In some embodiments, the first data source is associated with a first sensor type and the second data source is associated with a second sensor type different from the first sensor type. In certain embodiments, the operations further comprise: applying a first data transformation to the first data stream to generate a transformed first data stream; wherein the generating a second observation schema includes generating the second observation schema based at least in part on the transformed first data stream; applying a second data transformation to the second data stream to generate a transformed second data stream; wherein the generating a third observation schema includes generating the third observation schema based at least in part on the transformed second data stream.

In some embodiments, the operations further comprise: processing the data stream from the one or more data sources using the second observation schema to generate a data track, wherein the data track includes a plurality of observations, each observation of the plurality of observations being generated using the second observation schema. In certain embodiments, the second observation schema includes one or more static fields and one or more live fields, wherein the plurality of observations including a set of first observations and a set of second observations, wherein each first observation in the set of first observations includes at least one of the one or more static fields, wherein each second observation in the set of second observations does not include the at least one of the one or more static fields.

In some embodiments, the one or more data sources include data from a plurality of sensor types, wherein the data stream includes a first data stream corresponding to a first sensor type of the plurality of sensor types and a second data stream corresponding to a second sensor type of the plurality of sensor types, wherein the generating a second observation schema includes generating the second observation schema based on the first data stream; wherein the operations further comprise: generating a third observation schema based on the second data stream, the third observation schema being different from the second observation schema, the third observation schema including one or more built-in fields that are included in the second observation schema; generating a plurality of first observations based on the first data stream using the second observation schema; generating a plurality of second observations based on the second data stream using the third observation schema; and aggregating the plurality of first observations and the plurality of second observations based at least in part on the one or more built-in fields.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for managing one or more observation schemas, the method comprising:
receiving a data stream from one or more data sources;
accessing a first observation schema including one or more built-in fields and one or more custom fields associated with the received data stream;
receiving a configuration associated with at least one of the one or more custom fields; and
generating a second observation schema based on the configuration and the first observation schema;
wherein at least a part of the method is performed using one or more processors.

2. The method of claim 1, wherein the generating a second observation schema comprises generating the second observation schema while the first observation schema is in use, wherein the first observation schema is a first version of an observation schema and the second observation schema is a second version of the observation schema.

3. The method of claim 1, wherein the one or more built-in fields include at least one selected from a group consisting of a temporal data field and a geospatial data field.

4. The method of claim 1, wherein at least one of the one or more custom fields includes a live field corresponding to data updating at a first data rate, wherein at least one of the one or more custom fields includes a static field corresponding to date updating at a second data rate, wherein the first data rate is higher than the second data rate.

5. The method of claim 1, wherein the accessing a first observation schema includes identifying the first observation schema based on a user input.

6. The method of claim 1, wherein the generating a second observation schema includes generating the second observation schema via applying a machine learning model to the received data stream and the first observation schema.

7. The method of claim 6, wherein the machine learning model includes a large language model.

8. The method of claim 1, wherein the receiving a data stream includes identifying the data stream by a user input.

9. The method of claim 1, wherein the data stream is a first data stream, the configuration is a first configuration, wherein the method further comprises:
receiving a second data stream from the one or more data sources;
receiving a second configuration of at least one of the one or more custom fields; and
generating a third observation schema based on the second configuration and the first observation schema, the third observation schema being different from the second observation schema.

10. The method of claim 9, wherein the first data stream is received from a first data source and the second data stream is received from a second data source different from the first data source.

11. The method of claim 10, wherein the first data source is associated with a first sensor type and the second data source is associated with a second sensor type different from the first sensor type.

12. The method of claim 10, further comprising:
applying a first data transformation to the first data stream to generate a transformed first data stream;
wherein the generating a second observation schema includes generating the second observation schema based at least in part on the transformed first data stream;
applying a second data transformation to the second data stream to generate a transformed second data stream;
wherein the generating a third observation schema includes generating the third observation schema based at least in part on the transformed second data stream.

13. The method of claim 1, further comprising:
processing the data stream from the one or more data sources using the second observation schema to generate a data track, wherein the data track includes a plurality of observations, each observation of the plurality of observations being generated using the second observation schema.

14. The method of claim 13, wherein the second observation schema includes one or more static fields and one or more live fields, wherein the plurality of observations including a set of first observations and a set of second observations, wherein each first observation in the set of first observations includes at least one of the one or more static fields, wherein each second observation in the set of second observations does not include the at least one of the one or more static fields.

15. The method of claim 13, wherein the one or more data sources include data from a plurality of sensor types,
wherein the data stream includes a first data stream corresponding to a first sensor type of the plurality of sensor types and a second data stream corresponding to a second sensor type of the plurality of sensor types,
wherein the generating a second observation schema includes generating the second observation schema based on the first data stream;
wherein the method further comprises:
generating a third observation schema based on the second data stream, the third observation schema being different from the second observation schema, the third observation schema including one or more built-in fields that are included in the second observation schema;
generating a plurality of first observations based on the first data stream using the second observation schema;
generating a plurality of second observations based on the second data stream using the third observation schema; and
aggregating the plurality of first observations and the plurality of second observations based at least in part on the one or more built-in fields.

16. A method for using one or more observation schemas, the method comprising:
receiving a data stream from one or more data sources;
searching within the one or more observation schemas in a data repository based on at least one data characteristic in the data stream;
identifying an observation schema from the one or more observation schemas based on the search; and
processing the data stream using the identified observation schema to generate a plurality of observations;
wherein at least a part of the method is performed using one or more processors.

17. The method of claim 16, wherein the identified observation schema includes one or more static fields and one or more live fields, wherein the plurality of observations including a set of first observations and a set of second observations, wherein each first observation in the set of first observations includes at least one of the one or more static fields, wherein each second observation in the set of second observations does not include the at least one of the one or more static fields.

18. The method of claim 16, wherein the one or more data sources include data from a plurality of sensor types,
wherein the data stream includes a first data stream corresponding to a first sensor type of the plurality of sensor types and a second data stream corresponding to a second sensor type of the plurality of sensor types,
wherein the generating a second observation schema includes generating the second observation schema based on the first data stream;
wherein the method further comprises:
generating a third observation schema based on the second data stream, the third observation schema being different from the second observation schema, the third observation schema including one or more built-in fields that are included in the second observation schema;
generating a plurality of first observations based on the first data stream using the second observation schema;
generating a plurality of second observations based on the second data stream using the third observation schema; and
aggregating the plurality of first observations and the plurality of second observations based at least in part on the one or more built-in fields.

19. A system for managing one or more observation schemas, the system comprising:
one or more memories having instructions stored thereon; and
one or more processors configured to execute the instructions and perform operations comprising:
receiving a data stream from one or more data sources;
accessing a first observation schema including one or more built-in fields and one or more custom fields associated with the received data stream;
receiving a configuration associated with at least one of the one or more custom fields; and
generating a second observation schema based on the configuration and the first observation schema.

20. The system of claim 19, wherein at least one of the one or more custom fields includes a live field corresponding to data updating at a first data rate, wherein at least one of the one or more custom fields includes a static field corresponding to date updating at a second data rate, wherein the first data rate is higher than the second data rate.
